(19) United States
(12) Patent Application Publication
(10) Pub. No.: US 2009/0138209 A1
(43) Pub. Date: May 28, 2009

(54) PROGNOSTIC APPARATUS, AND PROGNOSTIC METHOD

(75) Inventors: Koji Maruhashi, Kawasaki (JP); Yoshio Nakao, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/264,613

(22) Filed: Nov. 4, 2008

(30) Foreign Application Priority Data
Nov. 22, 2007 (JP) 2007-302351

(51) Int. Cl. G06F 19/00

(52) U.S. Cl. 702/20

(57) ABSTRACT

A computer-readable storage medium storing a program causing a computer to execute, (a) extracting prediction factors from gene expression data, (b) predicting based on gene expression data of a patient to be prognosticated, whether expression levels of the prediction factors of the patient are similar to the expression levels of a good prognosis group or the expression levels of a poor prognosis group, and (c) extracting prediction factors indicating a poor prognosis from the prediction factors of the patient as poor prognosis determining factors. Poor prognosis determining factors are extracted in which increase and decrease trends of the expression levels coincide with increase and decrease trends of expression levels supposed when abnormal phenomena related to predetermined diseases occur, and the poor prognosis determining factors extracted for the respective abnormal phenomena are outputted.

### CROSS-REFERENCES TO RELATED APPLICATIONS

This application is based upon and claims the benefit of priority from the prior Japanese Patent Application No. 2007-302351 filed on Nov. 22, 2007, the entire contents of which are incorporated herein by reference.

### BACKGROUND

### Field

The embodiment discussed herein is related to a prognostic technique supporting prognostication in order to develop a therapeutic strategy for a patient.

### SUMMARY OF THE INVENTION

According to an aspect of the present invention, a computer-readable storage medium storing a prognostic program to prognosticate a patient using a gene expression data analysis, causing a computer to execute a prediction factor extraction process which selects, from gene expression data obtained from patients who have different prognosis, genes exhibiting significantly different standard expression levels between a good prognosis group and a poor prognosis group as prediction factors; a prognosis prediction process which determines, based on gene expression data of a patient to be prognosticated, whether expression levels of the prediction factors of the patient to be prognosticated are similar to the expression levels of the good prognosis group or the expression levels of the poor prognosis group; a poor prognosis-related factor extraction process which selects prediction factors indicating a poor prognosis from the prediction factors of the patient to be prognosticated as poor prognosis determining factors, and from the poor prognosis determining factors, extracts poor prognosis determining factors in which increase and decrease trends of the expression levels coincide with increase and decrease trends of expression levels supposed when abnormal phenomena related to predetermined diseases occur; and a poor prognosis-related factor information output process which outputs, when a poor prognosis is predicted in the prognosis prediction process, the poor prognosis determining factors extracted for the respective abnormal phenomena.

Additional aspects and/or advantages will be set forth in part in the description which follows, and in part will be apparent from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a view illustrating a prognostic process of the present invention;

FIGS. 2A and 2B are views each illustrating a poor prognostic chromosomal abnormality-related factor extraction process;

FIGS. 3A to 3C are views each illustrating a related chromosomal abnormality information output process;

FIG. 4 is a view showing a structural example of a prognostic apparatus;

FIGS. 5A to 5F are views each showing a structural example of information used in the prognostic apparatus;

FIG. 6 is a view illustrating an overall process of the prognostic apparatus;

FIG. 7 is a view illustrating a process of a prediction factor extraction portion;

FIG. 8 is a flowchart of a prediction factor extraction process;

FIG. 9 is a view illustrating a prognosis prediction process of a prognostic portion;

FIG. 10 is a flowchart of the prognosis prediction process;

FIG. 11 is a view illustrating a process of a chromosomal abnormality-related factor extraction portion;

FIG. 12 is a flowchart of a chromosomal abnormality-related factor extraction process;

FIG. 13 is another flowchart of the chromosomal abnormality-related factor extraction process;

FIG. 14 is a view illustrating a related chromosomal abnormality information output process of the prognostic portion;

FIG. 15 is a flowchart of the related chromosomal abnormality information output process; and

FIG. 16 is a view illustrating a related prognostic method.

### DETAILED DESCRIPTION OF THE PREFERRED EMBODIMENT

In recent years, because of development of a gene expression analytical technique, expression states of many genes have been easily and comprehensively measured. Accordingly, it becomes possible to precisely predict prognosis of a patient based on measurement results of gene expression states thereof.

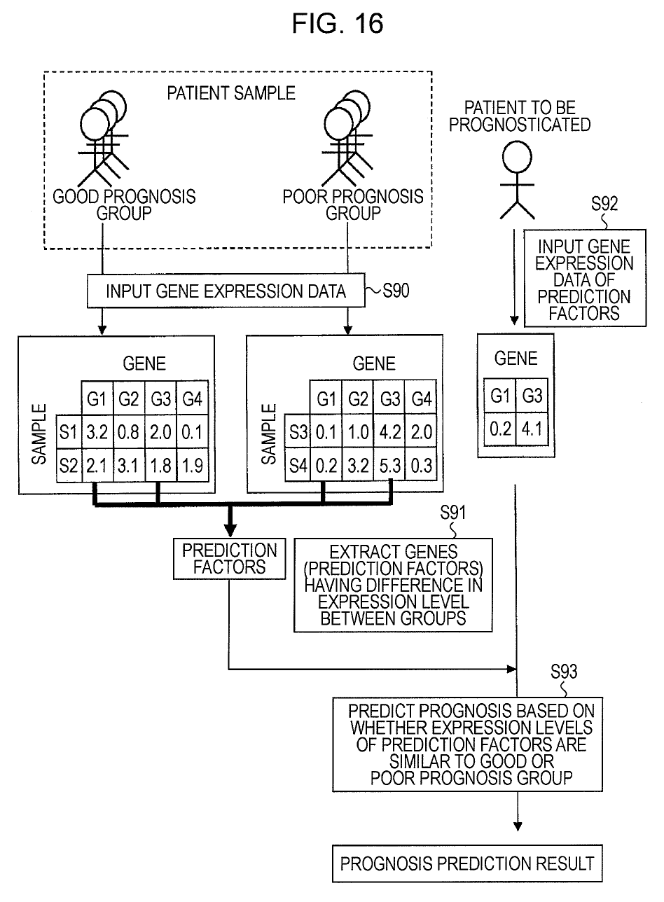

FIG. 16 is a view illustrating a related prognostic method using a gene expression analytical technique.

In prognosis prediction in general, a gene expression data of patients having different prognosis is observed (Step S90), and based on sample data obtained from a good prognosis patient group (good prognosis group) and a poor prognosis patient group (poor prognosis group), genes, the expression levels of which are increased or decreased in accordance with the degree of the prognosis, are extracted as prediction factors (Step S91). In addition, a gene expression data of the prediction factors of a patient to be prognosticated is observed (Step S92), and with reference to expression levels of the prediction factors, the prognosis of the patient to be prognosticated is predicted (Step S93).

However, in order to develop a therapeutic strategy, which is a primary purpose of the prognostication, only the prediction of prognosis is not sufficient, and each patient should be diagnosed in consideration of, for example, types of diseases (types of diseases which are, for example, classified in conjunction with the difference in occurrence of biological phenomena related to onset and/or deterioration of diseases) which relate to selection of an appropriate therapeutic treatment. Hence, heretofore, it has also been carried out that after samples of gene expression data of patient groups which belong to different disease types are prepared and analyzed, prediction factors are extracted in consideration of the difference between types of diseases (for example, refer to Hu Z et al. “The molecular portraits of breast tumors are conserved across microarray platforms.”, BMC Genomics Vol. 7, p. 96, US, April 2006).

In addition, a technique has been known in which an abnormal phenomenon related to disease progression is extracted using gene expression data. For example, in the cancer treatment field, since cancer progression can be explained in association with chromosomal abnormality in many cases, an attempt has been made in which, for example, abnormal regions of chromosomes, which are typically observed in a cancer patient group, are detected based on gene expression data obtained from many patients. For example, in “Visualizing Chromosomes as Transcriptome Correlation Maps Evidence of Chromosomal Domains Containing Co-expressed Genes-A Study of 130, Invasive Ductal Breast Carcinomas”, Cancer Research Vol. 65, pp. 1,376 to 83, US, February, 2005, written by Reyal et al., it has been disclosed that from gene expression data obtained from 130 breast cancer patients, when chromosomal regions are extracted where genes, the expression levels of which are synchronously increased and decreased, are collectively present, some of the above chromosomal regions show good coincidence with duplicated regions of chromosomes which are frequently observed in poor prognosis breast cancers.

In the related method in which samples of gene expression data of patient groups having different disease types are prepared and analyzed, and in which prediction factors in consideration of the difference in disease types are extracted, there has been a problem in that many types of good sample data must be prepared.

In addition, by the method as disclosed in the above document written by Reyal et al. in which from the gene expression data obtained from many cancer patients, the chromosomal regions are extracted where genes, the expression levels of which are synchronously increased and decreased, are collectively present, although abnormal phenomena, such as chromosomal abnormalities, related to disease progression, can be extracted, the method cannot be used for prognostication. The reasons for this are that the method is not a technique to detect abnormal phenomena generated in each patient, and the relationship between the prognosis and the abnormal phenomena cannot be obtained.

The embodiment of the present invention addresses the case in which in prognostication of a cancer patient performed by a prognostic apparatus realized by a computer. A process will be described that specifies disease-related phenomena, that is, chromosomal abnormalities, by way of example.

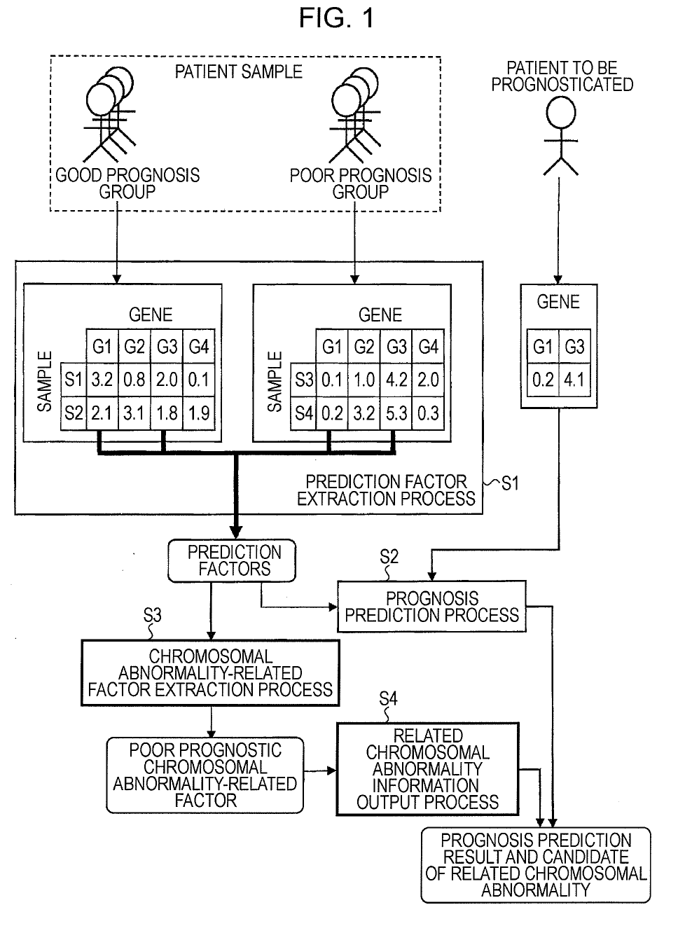

With reference to FIG. 1, the prognostic process of the present invention will be briefly described.

Step S1: Prediction Factor Extraction Process

Gene expression data obtained from a patient sample of patient groups having different prognosis (good prognosis group and poor prognosis group) is input by a user. The prognostic apparatus extracts genes showing significant differences in expression level between the good prognosis group and the poor prognosis group as prediction factors.

Step S2: Prognosis Prediction Process

Based on gene expression data of a patient who is to be prognosticated, expression levels of the prediction factors of the patient to be prognosticated are compared with those of the prediction factors of the good prognosis group and the poor prognosis group, and the prognosis of the patient to be prognosticated is predicted. For example, when expression levels of many prediction factors of the patient to be prognosticated are close to the respective standard expression levels (average value, medium value, and the like) of the good prognosis group, a good prognosis is predicted. On the other hand, when expression levels of many prediction factors are close to the respective standard expression levels of the poor prognosis group, a poor prognosis is predicted.

Step S3: Chromosomal Abnormality-Related Factor Extraction Process (Poor Prognosis-Related Factor Extraction Process)

By the method described later, genes (poor prognosis-related factors, and in this embodiment, poor prognostic chromosomal abnormality-related factors) are extracted from the prediction factors which are used for prediction of prognosis. In the genes thus extracted, increase and decrease trends of expression levels thereof coincide with increase and decrease trends of expression levels which are supposed when abnormal phenomena (in this embodiment, known chromosomal abnormalities related to onset/deterioration of cancer) related to specific diseases occur.

Step S4: Related Chromosomal Abnormality Information Output Process (Poor Prognosis-Related Factor Information Output Process)

In the case in which a poor prognosis is predicted in Step S2, by the method described later, candidates of abnormal phenomena (chromosomal abnormalities) estimated to be strongly associated with the poor prognosis are output as reference information. In particular, the prognostic prediction result in Step S2 and, as reference information, the poor prognostic chromosomal abnormality-related factors of the respective abnormal phenomena in Step S3 are submitted to the user.

In addition, the number of poor prognosis chromosomal abnormality-related factors of each abnormal phenomenon may be added as the degree of confidence, and as the reference information, candidates of abnormal phenomena each provided with the degree of confidence may be submitted to the user.

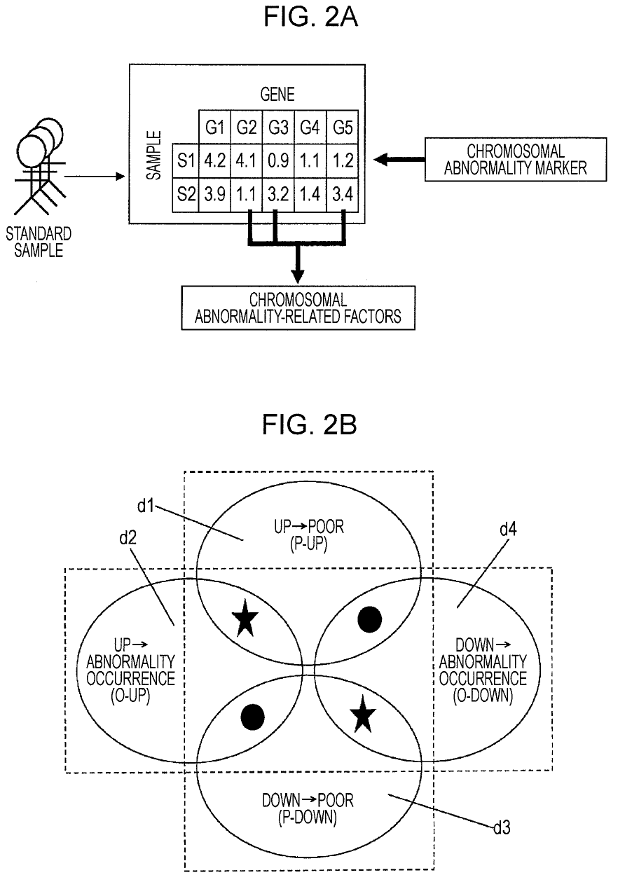

Next, with reference to FIGS. 2A and 2B, the chromosomal abnormality-related factor extraction process in Step S3 will be described in more detail.

In the chromosomal abnormality-related factor extraction process, the poor prognostic chromosomal abnormality-related factors (poor prognosis-related factors) are extracted by chromosomal abnormality markers.

The chromosomal abnormality markers are genes which are each believed, based on research carried out in the past, to indicate chromosomal abnormality depending on whether the expression level is increased or decreased. In this process, the gene group described above is classified into (O-UP type) genes in which the expression level is increased when chromosomal abnormality occurs and (O-DOWN type) genes in which the expression level is decreased when chromosomal abnormality occurs. Hereinafter, the former type is called an “O-UP type” marker, and the latter type is called an “O-DOWN type” marker.

As shown in FIG. 2A, gene expression data of a standard sample is input by the user into a computer which carries out this process.

The standard sample is a sample set which is supposed to appropriately include samples in which concerned chromosomal abnormalities occur and samples in which the concerned chromosomal abnormalities do not occur. The standard sample may be the same sample set as that of the patient sample used in the prediction factor extraction process (Step S1 in FIG. 1).

Subsequently, using the gene expression data of the standard sample, genes (chromosomal abnormality-related factors), the expression levels of which are increased and decreased in synchronous with those of the gene abnormality markers, are extracted. As the chromosomal abnormality-related factors, for example, Pearson's product-moment correlation coefficient is calculated between the expression level of the chromosomal abnormality marker and the expression level of each gene in the gene expression data of the standard sample, and genes each having an absolute value of the correlation coefficient larger than a predetermined threshold are extracted. In this case, in the chromosomal abnormality-related factors, the chromosomal abnormality markers are included.

Subsequently, by the method described below, the poor prognostic chromosomal abnormality-related factors are extracted.

In FIG. 2B, the ranges of circles arranged in the longitudinal direction show types of poor prognosis prediction factors.

The prediction factors are classified into genes “P-UP type poor factors” shown by a circular range d1, indicating a poor prognosis when the expression level is increased (P-UP) and genes “P-DOWN type poor factors” shown by a circular range d3, indicating a poor prognosis when the expression level is decreased (P-DOWN).

In addition, in FIG. 2B, the ranges of circles arranged in the lateral direction show types of chromosomal abnormality-related factors.

As in the case of the above abnormal markers, the chromosomal abnormality-related factors are classified into O-UP type genes “O-UP type abnormal factors” shown by a circular range d2, indicating chromosomal abnormality occurrence when the expression level is increased (O-UP) and O-DOWN type genes “O-DOWN type abnormal factors” shown by a circular range d4, indicating gene abnormality occurrence when the expression level is decreased (O-DOWN).

In the Venn diagram shown in FIG. 2B, an overlapped portion between the circular ranges d1 and d2 and an overlapped portion between the circular ranges d3 and d4 (portions shown by ▾ (star mark)) include genes, the changes in expression level of which each simultaneously indicate chromosomal abnormality and poor prognosis. The factors in the overlapped portions described above are believed to indicate a strong relationship between the chromosomal abnormality occurrence and the poor prognosis; hence, the factors in the ranges shown by “▾” are regarded as the “poor prognostic chromosomal abnormality-related factors”.

In addition, genes, the changes in expression level of which each do not simultaneously indicate chromosomal abnormality and poor prognosis, that is, the factors shown in the overlapped portion between the ranges d1 and d4 and those in the overlapped portion between the ranges d3 and d2 of the Venn diagram shown in FIG. 2B (portions shown by (circles)), indicate, for example, genes reducing influence on a living body when chromosomal abnormality occurs. That is, although indicating the chromosomal abnormality occurrence, the genes may be considered as genes which are not responsible for a poor prognosis (disease progression) or, conversely, may be considered as genes which suppress a poor prognosis; hence, in this process, the above genes are not regarded as factors to be extracted.

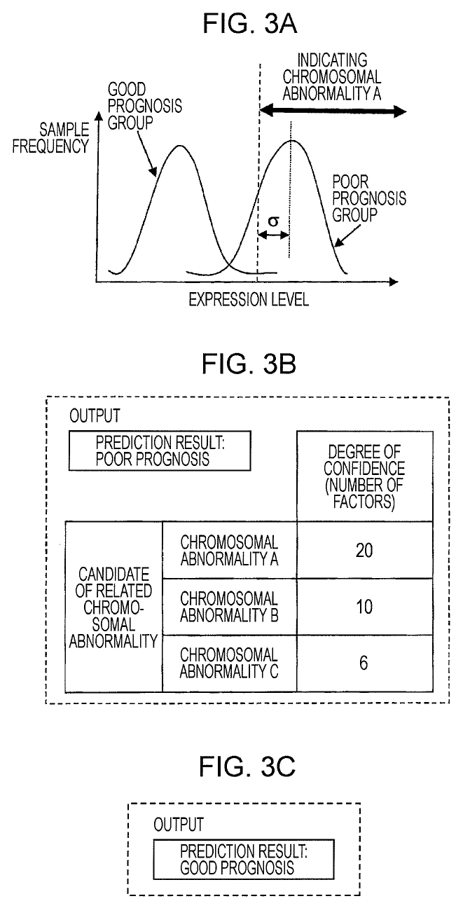

Next, with reference to FIGS. 3A to 3C, the related chromosomal abnormality information output process (poor prognosis-related factor information output process) will be described in more detail.

FIG. 3A is a view showing one example of expression distribution of a poor prognostic chromosomal abnormality-related factor g1, which relates to a certain chromosomal abnormality A, of the patient sample; FIG. 3B is a view showing an output information example in the case of poor prognosis prediction; and FIG. 3C is a view showing an output information example in the case of good prognosis prediction.

In the related chromosomal abnormality information output process, when the poor prognosis is predicted in the prognosis prediction process (Step S2), among the poor prognostic chromosomal abnormality-related factors, the number of factors of the patient to be prognosticated, which are present in the range (poor prognosis-indicating range) in which the expression levels thereof are regarded to show a poor prognosis, is counted.

As for the poor prognosis-indicating range, for example, in the expression distribution of the poor prognostic chromosomal abnormality-related factor g1 shown in FIG. 3A, when g1 is a P-UP type poor factor, a range higher than the value obtained by subtracting the standard deviation σ from the average value of the poor prognosis group in the gene expression data (patient sample) is regarded as a range of factors indicating the chromosomal abnormality A. In addition, when the poor prognostic chromosomal abnormality-related factor g1 is a P-DOWN type poor factor, a range lower than the value obtained by adding the standard deviation σ to the average value of the poor prognosis group in the patient sample is regarded as a range of factors indicating the chromosomal abnormality A.

In addition, for each chromosomal abnormality, the number of poor prognostic chromosomal abnormality-related factors of the patient to be prognosticated in the poor prognosis-indicating range is counted, and candidates of chromosomal abnormalities provided with the number of factors as the degree of confidence are submitted to the user as reference information.

In the case in which a poor prognosis of the patient to be prognosticated is predicted, the prognostic prediction result and the candidates of related chromosomal abnormalities are output in order from a higher degree of confidence (from a larger number of poor prognostic chromosomal abnormality-related factors), as shown in FIG. 3B. In addition, when a good prognosis is predicted for the patient to be prognosticated, the prognostic prediction result is only output as shown in FIG. 3C.

Hereinafter, examples of the present invention will be described.

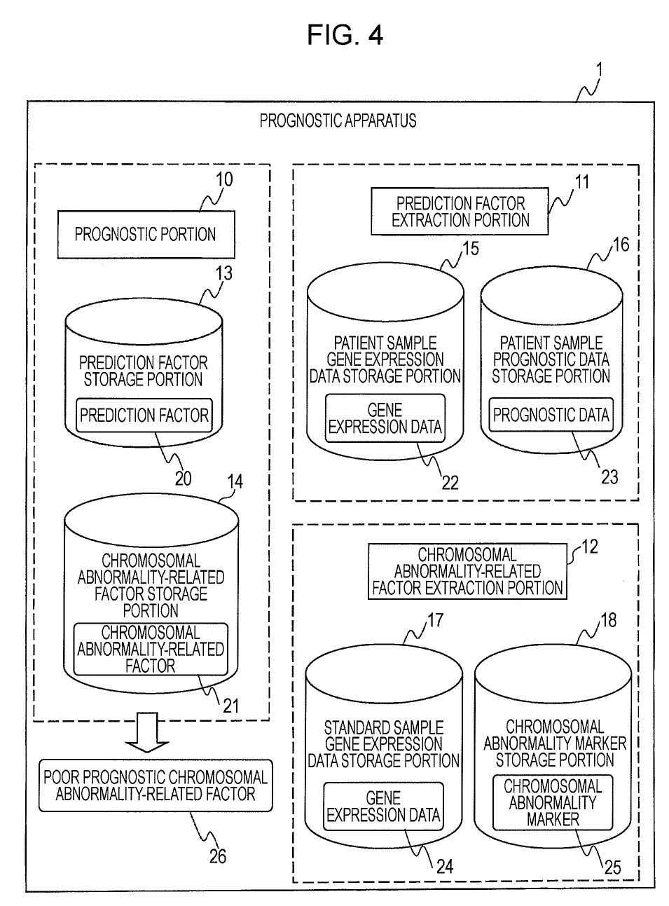

FIG. 4 is a view showing a structural example of a prognostic apparatus according to the present invention.

A prognostic apparatus 1 is a computer and includes a prognostic portion 10, a prediction factor extraction portion 11, and a chromosomal abnormality-related factor extraction portion 12, which are formed, for example, of software programs.

The prognostic portion 10 is a processing means for predicting prognosis based on expression levels of prediction factors of a patient to be prognosticated.

The prognostic portion 10 stores a prediction factor 20 in a prediction factor storage portion 13 and stores a chromosomal abnormality-related factor 21 in a chromosomal abnormality-related factor storage portion 14.

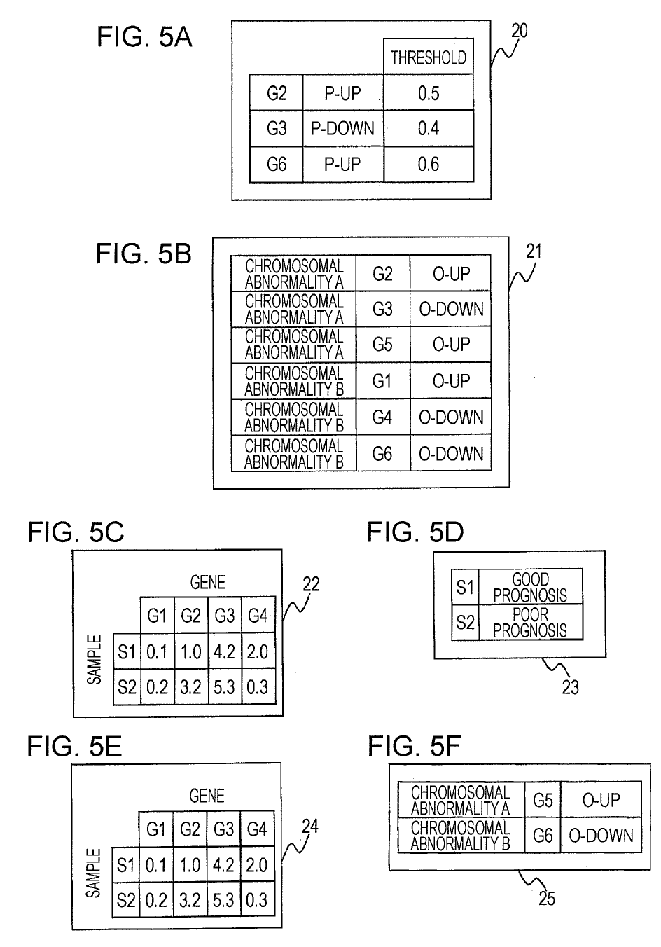

As shown in FIG. 5A, the prediction factor 20 is a data including gene IDs (Gn) of prediction factors, the relationship (P-UP/P-DOWN) between a poor prognosis and increase and decrease in expression level of the prediction factors, and thresholds of poor prognosis-indicating ranges.

As shown in FIG. 5B, the chromosomal abnormality-related factor 21 is data including chromosomal abnormalities indicated by chromosomal abnormality-related factors, gene IDs (Gn) of the chromosomal abnormality-related factors, and the relationship (O-UP/O-DOWN) between chromosomal abnormality occurrence and increase and decrease in expression level of the chromosomal abnormality-related factors.

The prognostic portion 10 inspects, in a prognosis prediction process, whether the expression level of each prediction factor of the patient to be prognosticated is in the poor prognosis-indicating range, and when the number of prediction factors in the poor prognosis-indicating range is larger than that in the range other than the poor prognosis-indicating range, a poor prognosis is predicted, and when the number is smaller, a good prognosis is predicted.

In addition, the prognostic portion 10 extracts, in a poor prognostic chromosomal abnormality-related factor extraction process, poor prognostic chromosomal abnormality-related factors 26 from the prediction factor 20 and the chromosomal abnormality-related factor 21. Subsequently, candidates of related chromosomal abnormalities of the patient are extracted with some degree of confidence by using the poor prognostic chromosomal abnormality-related factors 26, and are submitted to the user.

The prediction factor extraction portion 11 is a processing means for extracting the prediction factor 20 using gene expression data 22 of a patient sample and prognostic data 23 thereof.

The prediction factor extraction portion 11 stores the gene expression data 22 in a patient sample gene expression data storage portion 15 and stores the prognostic data 23 in a patient sample prognostic data storage portion 16.

The gene expression data 22 of the patient sample is, as shown in FIG. 5C, data including sample IDs (Sn), gene IDs (Gn), and gene expression levels of genes of the samples.

The prognostic data 23 of the patient sample is, as shown in FIG. 5D, data including sample IDs (Sn), and good and poor prognoses of the samples.

The prediction factor extraction portion 11 obtains, based on the prognostic data 23 of the patient sample, gene extraction data of a good prognosis group and that of a poor prognosis group from the gene expression data 22 of the patient sample. Furthermore, genes are extracted each having a significant difference in expression level between the good prognosis group and the poor prognosis group and are added to the prediction factor 20 in the prediction factor storage portion 13.

The chromosomal abnormality-related factor extraction portion 12 is a processing means for extracting the chromosomal abnormality-related factor 21 using gene expression data 24 of a standard sample and a chromosomal abnormality marker 25.

The chromosomal abnormality-related factor extraction portion 12 stores the gene expression data 24 in a standard sample gene expression data storage portion 17 and stores the chromosomal abnormality marker 25 in a chromosomal abnormality marker storage portion 18.

The gene expression data 24 of the standard sample is, as shown in FIG. 5E, data including sample IDs (Sn), gene IDs (Gn), and gene expression levels of genes of the samples.

The chromosomal abnormality marker 25 is, as shown in FIG. 5F, data including chromosomal abnormalities indicated by chromosomal abnormality markers, gene IDs (Gn) thereof, and the relationship (o-UP/O-DOWN) between increase and decrease in expression level of the chromosomal abnormality markers and the chromosomal abnormality occurrence.

The chromosomal abnormality-related factor extraction portion 12 calculates a correlation coefficient between the expression level of each chromosomal abnormality marker and that of each gene by using the gene expression data 24 of the standard sample. Subsequently, a gene in which the absolute value of the correlation coefficient with the chromosomal abnormality marker is larger than a predetermined value is added to the chromosomal abnormality-related factor 21 which indicates the same chromosomal abnormality as that of the chromosomal abnormality marker.

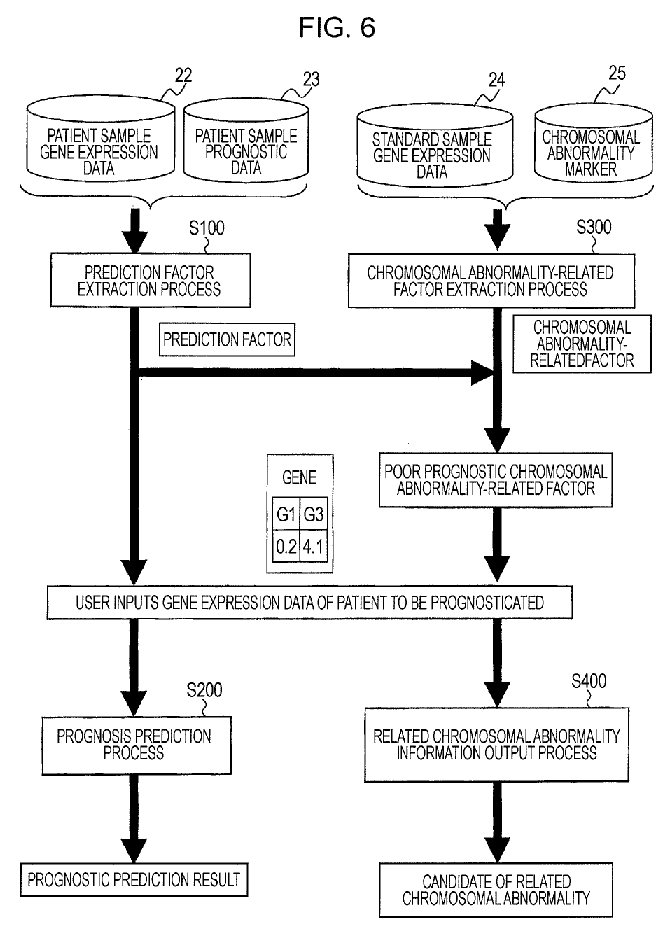

Next, with reference to FIG. 6, a process flow of the prognostic apparatus 1 will be described.

In the prognostic apparatus 1, the prediction factor extraction portion 11 performs a prediction factor extraction process (Step S100), the prognostic portion 10 performs the prognosis prediction process (Step S200), the chromosomal abnormality-related factor extraction portion 12 performs the chromosomal abnormality-related factor extraction process (Step S300), and the prognostic portion 10 performs a related chromosomal abnormality information output process (Step S400). Subsequently, the prognosis prediction of the patient to be prognosticated and the information of related chromosomal abnormality-related factors in the case of a poor prognosis are submitted to the user.

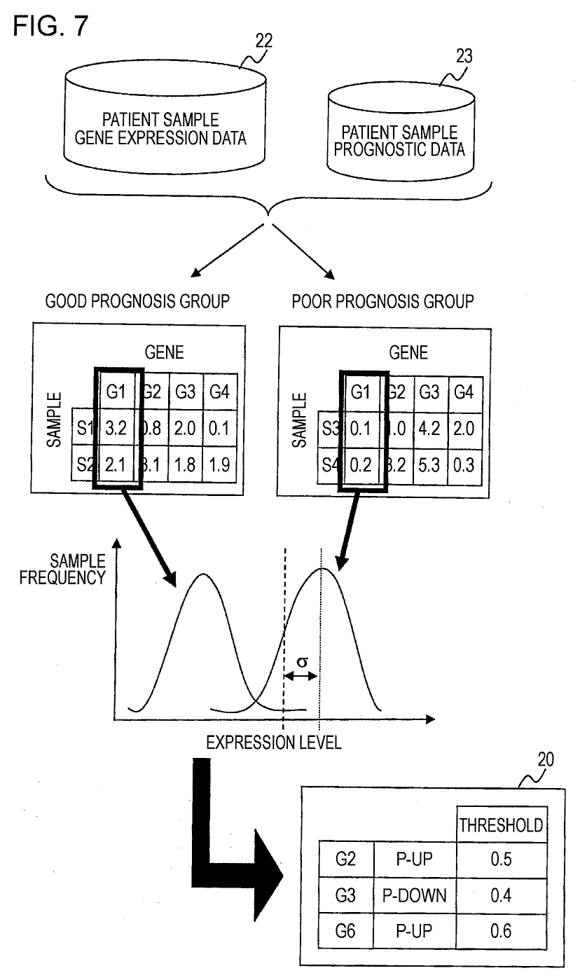

With reference to FIG. 7, the prediction factor extraction process (Step S100) will be described in more detail.

The prediction factor extraction portion 11 obtains the gene expression data of the good prognosis group and the gene expression data of the poor prognosis group based on the gene expression data 22 of the patient sample and the prognostic data 23 thereof.

Subsequently, the difference in population mean between the good prognosis group and the poor prognosis group is calculated with Welch's t test. The number of samples of the good prognosis group, the sample mean of the expression level of a gene g in the good prognosis group, and the sample variance are represented by Nn, Mn(g), and sn(g)2, respectively, and the number of samples of the poor prognosis group, the sample mean of the expression level of a gene g in the poor prognosis group, and the sample variance are represented by Nb, Mb(g), and sb(g)2, respectively.

In this case, the test statistic T={Mn(g)−Mb(g)}/{sn(g)2/Nn+sb(g)2/Nb}/2 is obtained. The test statistic T is assumed to follow the t distribution with m degree of freedom={sn(g)2/Nn+sb(g)2/Nb}2/{sn(g)4/Nn2(Nn−1)+sb(g)4/Nb2(Nb−1)}, and the null hypothesis (population mean of the good prognosis group being equal to that of the poor prognosis group) is tested at a predetermined significant level with the two-sided test. In this case, when m indicating the degree of freedom is not an integer, an integer closest to m is regarded as the degree of freedom. When the null hypothesis is rejected, the expression level of the gene g in the good prognosis group is regarded to be significantly different from that in the poor prognosis group, and the gene g is added to the prediction factor 20.

Furthermore, the prediction factor extraction portion 11 records the relationship between the poor prognosis and the increase and decrease in expression level of the extracted prediction factor in the prediction factor 20. When the average value of the expression level of the gene extracted as the prediction factor in the poor prognosis group is higher than that in the good prognosis group, a P-UP type poor factor (P-UP) is recorded, and when the above average value in the poor prognosis group is lower than that in the good prognosis group, a P-DOWN type poor factor (P-DOWN) is recorded.

Furthermore, the prediction factor extraction portion 11 records a threshold L(g) of the poor prognosis-indicating range in the prediction factor 20. In the case of a P-UP type poor factor, L(g)=Mb(g)−sb(g) is recorded, and in the case of a P-DOWN type poor factor, L(g)=Mb(g)+sb(g) is recorded.

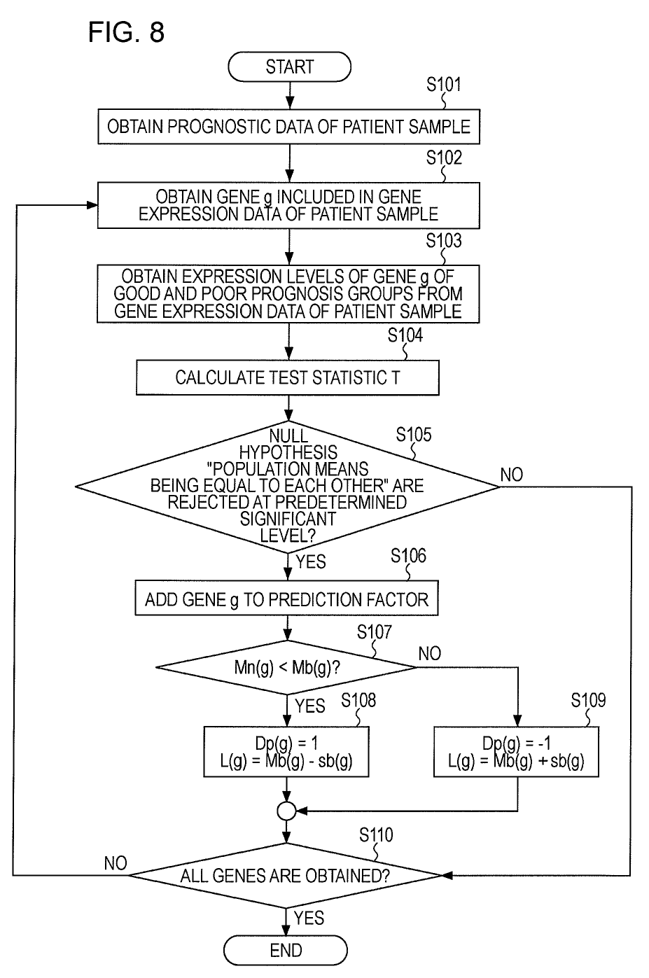

FIG. 8 is a flowchart of the prediction factor extraction process.

The prediction factor extraction portion 11 performs the following steps by obtaining the expression levels of genes one by one from the gene expression data 22 of the patient sample.

The prediction factor extraction portion 11 obtains the prognostic data 23 (Step S101), and obtains the gene g included in the gene expression data 22 (Step S102). Furthermore, based on the prognostic data 23, the expression level of the gene g in the good prognosis group and that in the poor prognosis group are obtained from the gene expression data 22 (Step S103).

In addition, the test statistic T is calculated (Step S104), and the null hypothesis (population mean of the good prognosis group being equal to that of the poor prognosis group) is tested at a predetermined significant level with the two-sided test (Step S105). When the null hypothesis is not rejected (No in Step S105), the process is advanced to Step S110. On the other hand, when the null hypothesis is rejected (Yes in Step S105), the gene g is added to the prediction factor 20 (Step S106).

Furthermore, classification into the P-UP type poor factor or the P-DOWN type poor factor and calculation of the threshold of the poor prognosis-indicating range are performed (Steps S107 to 109).

As for the gene g, the sample mean Mn(g) of the expression level of the good prognosis group and the sample mean Mb(g) of the expression level of the poor prognosis group are compared with each other (Step S107), and when Mn(g) is smaller than Mb(g) (Yes in Step S107), as a P-UP type poor factor, 1 is recorded as Dp(g) indicating a direction of the expression level of the prediction factor g, and the threshold L(g)=Mb(g)−sb(g) of the poor prognosis-indicating range is recorded (Step S108).

In addition, when Mn(g) is larger than Mb(g) (No in Step S107), as a P-DOWN type poor factor, −1 is recorded as Dp(g), so that the threshold L(g)=Mb(g)+sb(g) of the poor prognosis-indicating range is recorded (Step S109).

The process from Steps S103 to S109 is repeatedly performed for all genes, and when the genes are all processed (Yes in Step S110), the process is ended.

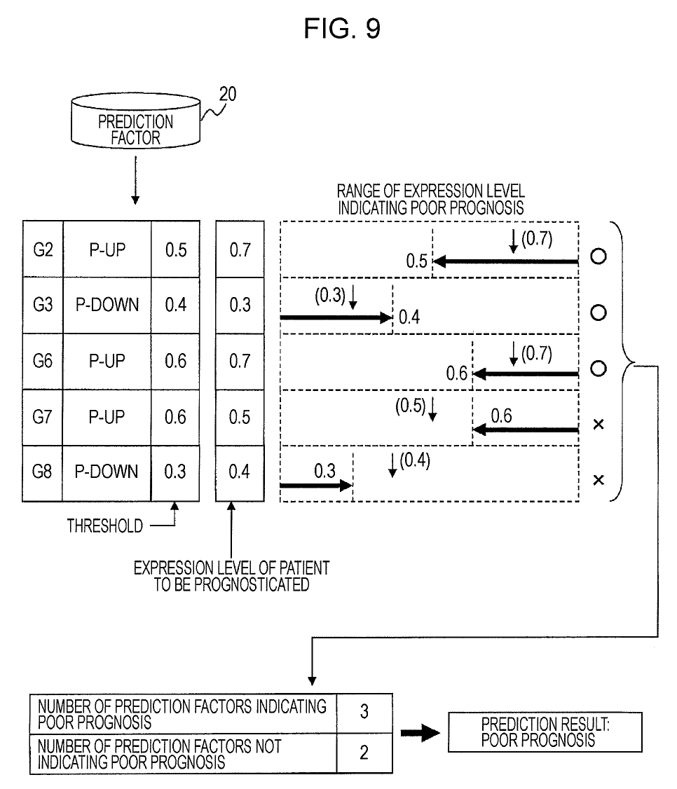

With reference to FIG. 9, the prognosis prediction process (Step S200) will be described in more detail.

When the gene expression data of the patient to be prognosticated is input by the user, the prognostic portion 10 compares the expression levels of the prediction factors of the patient to be prognosticated with the respective poor prognosis-indicating ranges (ranges each specified by the relationship (P-UP/P-DOWN) between the poor prognosis and the increase and decrease in expression level of the prediction factor and the threshold L(g) in the poor prognosis-indicating range), and the number of prediction factors present in the poor prognosis-indicating range is counted.

In this case, when the prediction factor is a P-UP type poor factor and its expression level is the threshold or more, and when the prediction factor is a P-DOWN type poor factor and its expression level is the threshold or less, the prediction factor is regarded in the poor prognosis-indicating range, and the prognosis of the patient to be prognosticated is considered to be poor. Subsequently, by majority decision, when the number of prediction factors in the poor prognosis-indicating ranges is larger than that outside the poor prognosis-indicating ranges, the prognosis of the patient to be prognosticated is predicted to be poor.

In an example shown in FIG. 9, as for prediction factors (genes) G2, G6, and G7, which are P-UP type poor factors of the prediction factor 20, when their expression levels of the patient to be prognosticated are higher than the respective thresholds, the above prediction factors are regarded in the respective poor prognosis-indicating ranges, and when the expression levels of prediction factors G3 and G8, which are P-DOWN type poor factors of the prediction factor 20, are lower than the respective thresholds, the above prediction factors are regarded in the respective poor prognosis-indicating ranges.

In this case, the prediction factors G2, G3, and G6 are in the respective poor prognosis-indicating ranges. In addition, the prediction factors G7 and G8 are not in the respective poor prognosis-indicating ranges. Accordingly, the number of prediction factors indicating poor prognosis is 3, and the number of prediction factors indicating no poor prognosis is 2; hence, by majority decision, the prognosis of the patient to be prognosticated is predicted to be poor.

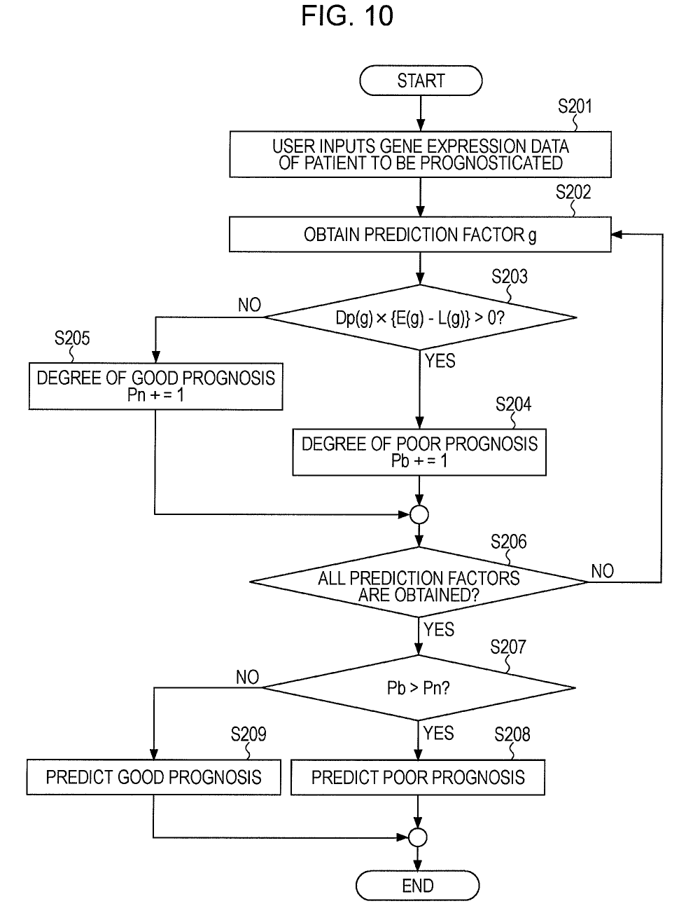

FIG. 10 is a flowchart of the prognosis prediction process.

The prognostic portion 10 obtains the prediction factor g (Step S202) when the gene expression data of the patient is input in the prognostic apparatus by the user (Step S201). The expression level of the prediction factor g is inspected to see whether it is in the poor prognosis-indicating range or not (Step S203).

In this case, when Dp(g)×{E(g)−L(g)} is positive, where Dp(g) indicates the direction of the expression level of the prediction factor g, E(g) indicates the expression level of the prediction factor g, and L(g) indicates the threshold of the poor prognosis-indicating range of the prediction factor g, the prediction factor g is regarded as indicating a poor prognosis. In addition, when Dp(g)×{E(g)−L(g)} is 0 or less, the prediction factor g is regarded as indicating a good prognosis (when the prediction factor g is a P-UP type poor factor, Dp(g)=1 holds, and when the prediction factor g is a P-DOWN type poor factor, Dp(g)=−1 holds).

In addition, when the prediction factor g is a P-UP type poor factor, and E(g) is larger than L(g), Dp(g)×{E(g)−L(g)} is positive. When the prediction factor g is a P-DOWN type poor factor, and E(g) is smaller than L(g), Dp(g)×{E(g)−L(g)} is positive.

When the prediction factor g indicates a poor prognosis (Yes in Step S203), 1 is added to the degree of poor prognosis Pb (Step S204). When the prediction factor g indicates a good prognosis (No in Step S203), 1 is added to the degree of good prognosis Pn (Step S205).

The process from Steps S203 to S205 is repeatedly performed for all prediction factors g, and after the process is completed, the process is advanced to Step S207 (Step S206).

Subsequently, Pb and Pn are compared with each other (Step S207), and when Pb is larger than Pn (Yes in Step S207), a poor prognosis is predicted (Step S208). When Pb is not larger than Pn (No in Step S207), a good prognosis is predicted (Step S209).

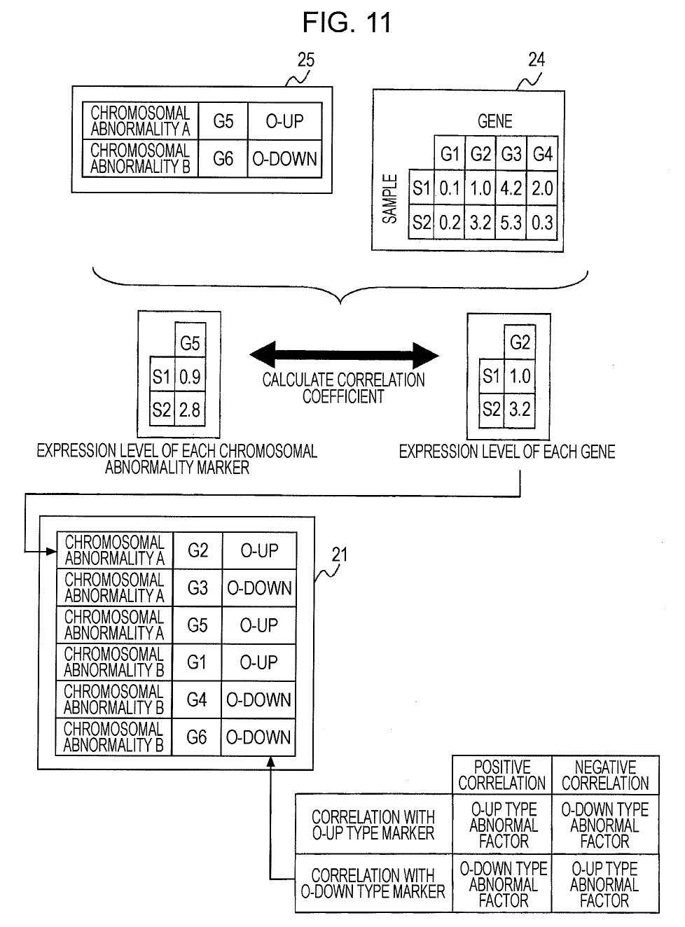

With reference to FIG. 11, the chromosomal abnormality-related factor extraction process (Step S 300) will be described in more detail.

The chromosomal abnormality-related factor extraction portion 12 calculates Pearson's product-moment correlation coefficient with the expression level of the chromosomal abnormality marker 25 using the gene expression data 24 of the standard sample.

In this case, the correlation coefficient sxy/(sx-sy) is calculated where the sample variance of the expression level of a chromosomal abnormality marker x indicating a chromosomal abnormality f is represented by sx2, the sample variance of the expression level of a gene y is represented by sy2, and the sample covariance of the expression level of x and that of y is represented by sxy.

Subsequently, when the absolute value of the correlation coefficient is a predetermined value or more, the gene y is added to the chromosomal abnormality-related factor 21 which indicates the chromosomal abnormality f. In addition, the chromosomal abnormality marker x is also included in the chromosomal abnormality-related factor 21 which indicates the chromosomal abnormality f.

Furthermore, the relationship between increase and decrease in expression level of extracted chromosomal abnormality-related factors and chromosomal abnormality occurrence is recorded in the chromosomal abnormality-related factor 21. When the chromosomal abnormality-related factor has a positive correlation with an O-UP type marker or a negative correlation with an O-DOWN marker, it is regarded as an O-UP type abnormal factor. In addition, when the chromosomal abnormality-related factor has a negative correlation with an O-UP type marker or a positive correlation with an O-DOWN marker, it is regarded as an O-DOWN type abnormal factor.

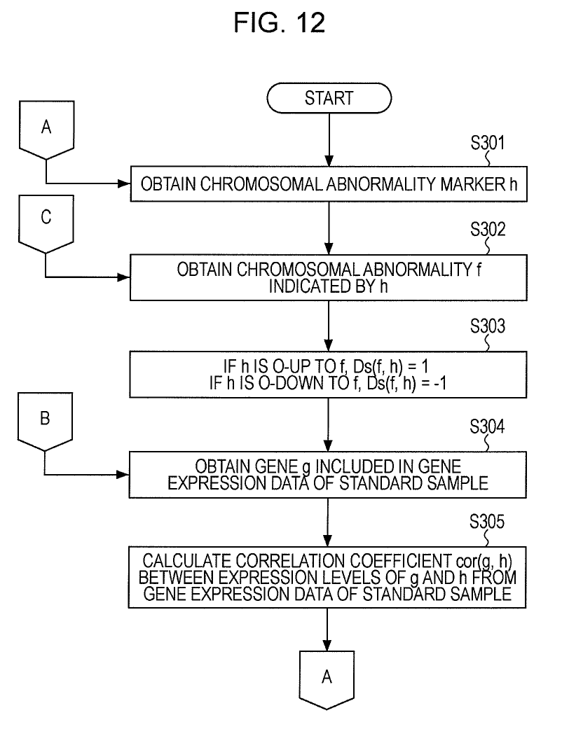

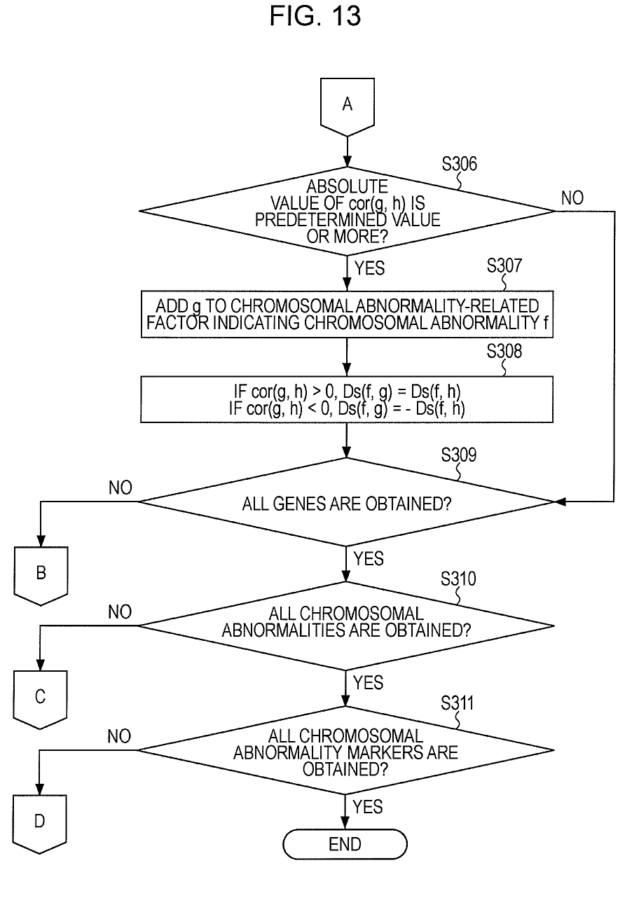

FIGS. 12 and 13 are flowcharts showing the chromosomal abnormality-related factor extraction process.

In the chromosomal abnormality-related factor extraction process, from all combinations between chromosomal abnormality markers and chromosomal abnormalities indicated thereby, genes, the expression levels of which are changed in conjunction with those of the chromosomal abnormality markers, are extracted and are then added to the chromosomal abnormality-related factor 21.

The chromosomal abnormality-related factor extraction portion 12 obtains a chromosomal abnormality marker h (Step S301) and obtains a chromosomal abnormality f indicated by the chromosomal abnormality marker h (Step S302). When the chromosomal abnormality marker h is an O-UP type marker with respect to the chromosomal abnormality f, Ds(f, h)=1 is recorded, and when the chromosomal abnormality marker h is an O-DOWN type marker with respect to the chromosomal abnormality f, Ds(f, h)=−1 is recorded (Step S303).

Furthermore, a gene g included in the gene expression data 24 of the standard sample is obtained (Step S304). The expression level of the gene g of each sample of the gene expression data 24 of the standard sample and the expression level of the chromosomal abnormality marker h are obtained, and Pearson's product-moment correlation coefficient cor(g, h) between the gene g and the chromosomal abnormality marker h is calculated (Step S305). When the absolute value of the correlation coefficient cor(g, h) is a predetermined value or more (Yes in Step S306), the process is advanced to Step S307. When the absolute value of the correlation coefficient cor(g, h) is less than the predetermined value (No in Step S306), the process is advanced to Step S309.

The gene g is added to the chromosomal abnormality-related factor 21 which indicates the chromosomal abnormality f (Step S307). Furthermore, the relationship between the increase and decrease in expression level of the gene g and the occurrence of the chromosomal abnormality f is recorded in the chromosomal abnormality-related factor 21 (Step S308). When the gene g has a positive correlation with the chromosomal abnormality marker h (cor(g, h)>0), Ds(f, g) is regarded to be equal to Ds(f, h) (Ds(f, g)=Ds(f, h)) (being equal to the relationship between the increase and decrease in expression level of the chromosomal abnormality marker h and the occurrence of the chromosomal abnormality f). On the other hand, when the gene g has a negative correlation with the chromosomal abnormality marker h (cor(g, h)<0), Ds(f, g) is regarded to be equal to −Ds(f, h) (Ds(f, g)=−Ds(f, h)) (being opposite to the relationship between the increase and decrease in expression level of the chromosomal abnormality marker h and the occurrence of the chromosomal abnormality f). As a result, when the gene g is an O-UP type abnormal factor with respect to the chromosomal abnormality f, Ds(f, g)=1 is recorded, and when the gene g is an O-DOWN type abnormal factor with respect to the chromosomal abnormality f, Ds(f, g)=−1 is recorded.

The process from Steps S305 to S308 is repeatedly performed for all genes included in the gene expression data 24 of the standard sample, and after the process is performed for all the genes, the process is advanced to Step S310 (Step S309).

Furthermore, the process from Steps S304 to S309 is repeatedly performed for all chromosomal abnormalities indicated by the chromosomal abnormality marker h, and after the process is performed for all the genes, the process is advanced to Step S311 (Step S310).

In addition, the process from Steps S302 to S310 is repeatedly performed for all chromosomal abnormality markers, and after the process is performed for all the genes (Yes in Step S311), the process is ended.

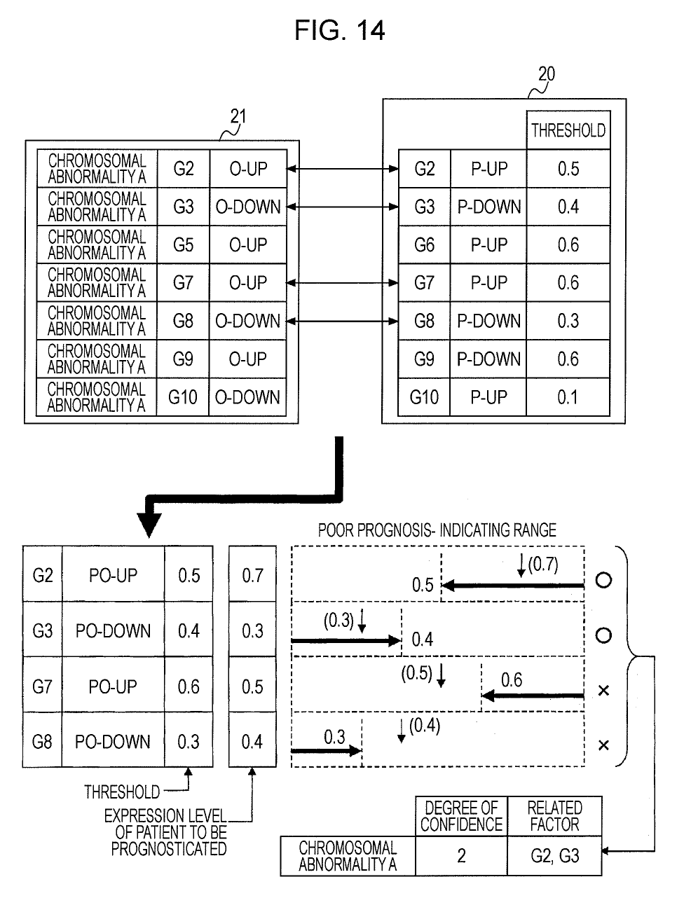

With reference to FIG. 14, the related chromosomal abnormality information output process (Step S400) will be described in more detail.

From the prediction factor 20 and the chromosomal abnormality-related factor 21, the prognostic portion 10 extracts genes, the changes in expression level of which each simultaneously indicate chromosomal abnormality and poor prognosis, as the poor prognostic chromosomal abnormality-related factors 26. In particular, genes (PO-UP type factor), each of which is a P-UP type poor factor and an O-UP type abnormal factor, and genes (PO-DOWN type factor), each of which is a P-DOWN type poor factor and an O-DOWN type abnormal factor, are extracted as the poor prognostic chromosomal abnormality-related factors 26.

In addition, the poor prognostic chromosomal abnormality-related factors 26 in the gene expression data of the patient to be prognosticated, the expression levels of which are in the poor prognosis-indicating ranges, are extracted. In this case, when the poor prognostic chromosomal abnormality-related factor is a PO-UP type factor, and the expression level thereof is the threshold or more, the factor is regarded in the poor prognosis-indicating range, and when the poor prognostic chromosomal abnormality-related factor is a PO-DOWN type factor, and the expression level thereof is the threshold or less, the factor is regarded in the poor prognosis-indicating range. Furthermore, with the number of the poor prognostic chromosomal abnormality-related factors in the poor prognosis-indicating range, which is regarded as the degree of confidence of a candidate of chromosomal abnormality causing a poor prognosis in the patient to be prognosticated, candidates of chromosomal abnormalities are submitted to the user.

In this case, as for chromosomal abnormality A, genes G2, G3, G7, and G8, the changes in expression level of which each simultaneously indicate chromosomal abnormality and poor prognosis, are extracted as the poor prognostic chromosomal abnormality-related factors 26. Accordingly, the number of the poor prognostic chromosomal abnormality-related factors, G2 and G3, the expression levels of which are in the poor prognosis-indicating ranges, of the patient to be prognosticated is 2, and this number is regarded as the degree of confidence of the chromosomal abnormality A.

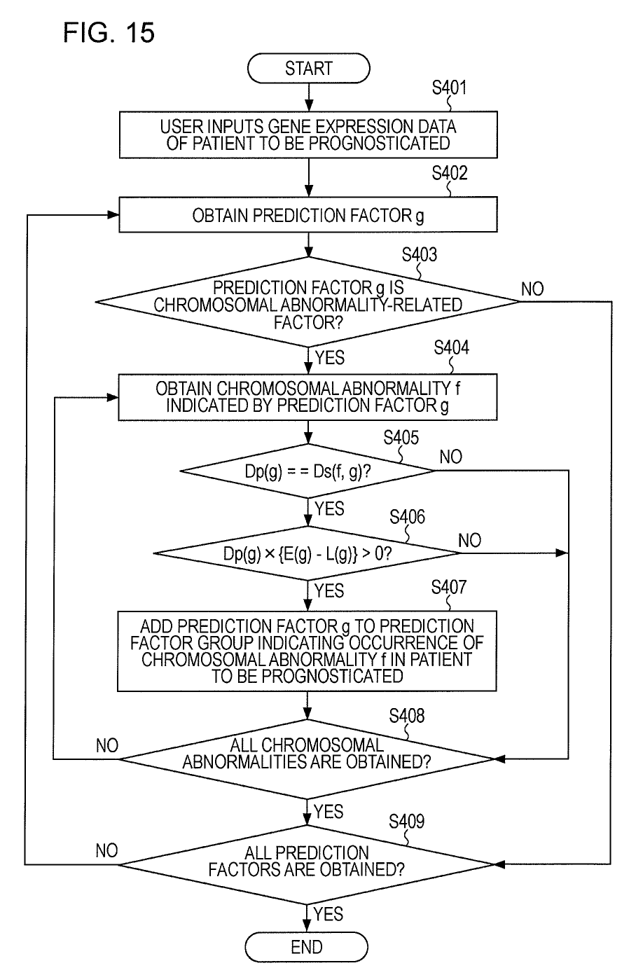

FIG. 15 is a flowchart of the related chromosomal abnormality information output process.

When the gene expression data of the patient to be prognosticated is input in the prognostic apparatus by the user (Step S401), the prognostic portion 10 obtains a prediction factor g (Step S402).

When the prediction factor g is the chromosomal abnormality-related factor 21 (Yes in Step S403), the process is advanced to Step S404, and when the prediction factor g is not the chromosomal abnormality-related factor 21 (No in Step S403), the process is advanced to Step S409.

The chromosomal abnormality f indicated by the prediction factor g is obtained (Step S404).

The prediction factor g is checked to see whether it is a poor prognostic chromosomal abnormality-related factor or not (Step S405). That is, the relationship between the increase and decrease in expression level of the gene g and the occurrence of the chromosomal abnormality f coincides with the relationship between the increase and decrease in expression level of the gene g and a poor prognosis (Dp(g)==Ds(f, g)), the prediction factor g is regarded as the poor prognostic chromosomal abnormality-related factor 26. When the prediction factor g is the poor prognostic chromosomal abnormality-related factor 26 (Yes in Step S405), the process is advanced to Step S406, and when the prediction factor g is not the poor prognostic chromosomal abnormality-related factor 26 (No in Step S405), the process is advanced to Step S408.

The expression level of the prediction factor g is checked whether it is in the poor prognosis-indicating range or not (Step S406). That is, when D(p)×{E(g)−L(g)} is positive, the prediction factor g is regarded as indicating a poor prognosis, and when it is 0 or less, the prediction factor g is regarded as indicating good prognosis, where Dp(g) represents the direction of the expression level of the prediction factor g which indicates a poor prognosis, E(g) represents the expression level of the prediction factor g, and L(g) represents the threshold of the poor prognosis-indicating range of the prediction factor g.

In addition, when the prediction factor g is a PO-UP type factor, Dp(g)=1 holds, and when the prediction factor g is a PO-DOWN type factor, Dp(g)=−1 holds. In the case of the PO-UP type factor, when E(g) is larger than L(g), D(p)×{E(g)−L(g)} is positive, and in the case of the PO-DOWN type factor, when E(g) is smaller than L(g), D(p)×{E(g)−L(g)} is positive.

When the prediction factor g indicates a poor prognosis (Yes in Step S406), the prediction factor g is added to the prediction factor 20 which indicates the occurrence of the chromosomal abnormality f in the patient to be prognosticated (Step S407).

The process from Steps S405 to S407 is repeatedly performed for all chromosomal abnormalities indicated by the prediction factor g, and when the process is performed for all the chromosomal abnormalities, the process is advanced to Step S409 (Step S408).

Furthermore, the process from Steps S403 to S408 is repeatedly performed for all prediction factors, and when the process is performed for all the prediction factors (Step S409), the process is ended.

By the processes described above, besides the prediction factor result of the prognosis of the patient to be prognosticated, the user can obtain, as reference information, poor prognosis determining factors for respective abnormal phenomena (chromosomal abnormalities and the like) which have possibly occurred in the patient to be prognosticated and which are estimated based on increase and decrease trends in expression levels of the prediction factors (poor prognosis determining factors) used as the base of the poor prognosis prediction.

In addition, with reference to the output prognosis prediction and the factors associated with abnormal phenomena related to a poor prognosis, the user can develop an appropriate therapeutic strategy in conjunction with the probability of occurrence of the abnormal phenomena.

In addition, when a plurality of abnormal phenomena related to the predicted poor prognosis is present, the user can develop an appropriate therapeutic strategy with reference to the abnormal phenomena in order from a higher degree of confidence.

Accordingly, as a result, the prognostic program of the present invention can be expected to improve the quality of life (QOL) of patients.

The present invention has been described in accordance with the embodiment; however, it is to be naturally understood that various changes and modifications may be made without departing from the spirit and scope of the present invention.

The program of the present invention may be stored in an appropriate recording medium, such as a computer-readable portable memory, semiconductor memory, or hard disc, and may then be provided, or the program may also be provided by transmission using various communication networks via communication interfaces.

What is claimed is:

1. A computer-readable storage medium storing a prognostic program to prognosticate a patient using a gene expression data analysis, causing a computer to execute:
a prediction factor extraction process which selects, from gene expression data obtained from patients who have different prognosis, genes which have significant difference between standard expression level for a good prognosis group and that for a poor prognosis group as prediction factors;
a prognosis prediction process which determines, based on gene expression data of a patient to be prognosticated, whether expression levels of the prediction factors of the patient to be prognosticated are similar to the expression levels of the good prognosis group or the expression levels of the poor prognosis group;
a poor prognosis-related factor extraction process which selects prediction factors indicating a poor prognosis from the prediction factors of the patient to be prognosticated as poor prognosis determining factors, and which, from the poor prognosis determining factors, extracts poor prognosis determining factors in which increase and decrease trends of the expression levels coincide with increase and decrease trends of expression levels supposed when abnormal phenomena related to predetermined diseases occur; and
a poor prognosis-related factor information output process which outputs, when a poor prognosis is predicted in the prognosis prediction process, the poor prognosis determining factors extracted for the respective abnormal phenomena.

2. The computer-readable storage medium storing a prognostic program according to claim 1, wherein the poor prognosis-related factor extraction process estimates,
based on (i) at least one abnormal marker gene which is known such that its expression level is increased or decreased when the abnormal phenomena occur, and (ii) gene expression data collected from a plurality of examinees who experienced the abnormal phenomena under different occurrence conditions,
increase and decrease trends of expression levels of non-marker genes other than the abnormal marker gene in consideration of the relationship between the expression level of the abnormal marker gene and the expression levels of the non-marker genes in the gene expression data,
so that based on the estimation result, the poor prognosis determining factors are extracted.

3. The computer-readable storage medium storing a prognostic program according to claim 1, wherein based on the number of the poor prognosis determining factors extracted for the respective abnormal phenomena, the poor prognosis-related factor extraction process obtains the degrees of confidence of the occurrence of the respective abnormal phenomena in the patient to be prognosticated, and the poor prognosis-related factor information output process outputs abnormal phenomenon information as the reference information in order from a higher degree of confidence.

4. The computer-readable storage medium storing a prognostic program according to claim 1, further causing a computer to execute: a poor prognosis determining information storage process in which
among genes, the expression levels of which are supposed to be increased or decreased when the abnormal phenomena occur,
genes are selected which are included in the prediction factors and in which increase and decrease trends in expression level of the genes of the poor prognosis group coincide with increase and decrease trends in expression level when the abnormal phenomena occur, and
ranges of the expression levels of the selected genes, which are used for selecting the poor prognosis determining factors, are stored as poor prognosis determining information in a storage portion.

5. A prognostic apparatus to prognosticate a patient using a gene expression data analysis, comprising:
a patient gene expression data storage unit storing gene expression data obtained from patient groups having different prognosis;
a gene expression data storage unit storing gene expression data of a patient to be prognosticated;
a prediction factor extraction unit selecting genes as prediction factors, the genes which have significant difference between standard expression level for a good prognosis group and that for a poor prognosis group;
a prognosis prediction unit determining, based on the gene expression data of the patient to be prognosticated, whether the expression level of each of the prediction factors of the patient to be prognosticated is similar to the expression level of the good prognosis group or the expression level of the poor prognosis group;
a poor prognosis-related factor extraction unit which selects poor prognosis determining factors, which are genes indicating a poor prognosis, from the prediction factors of the patient to be prognosticated and which, from the poor prognosis determining factors, extracts poor prognosis determining factors in which increase and decrease trends of expression levels coincide with increase and decrease trends of expression levels supposed when abnormal phenomena related to predetermined diseases occur; and
a poor prognosis-related factor information output unit which outputs, when the prognosis of the patient to be prognosticated is predicted to be poor in the prognosis prediction portion, the poor prognosis determining factors extracted for the respective abnormal phenomena.

6. A prognostic method for prognosticating a patient, which is carried out by a computer using a gene expression data analysis, comprising the steps of:
selecting genes as prediction factors from gene expression data obtained from patients having different prognosis, the genes which have significant difference between standard expression level for a good prognosis group and that for a poor prognosis group;
determining, based on gene expression data of a patient to be prognosticated, whether expression levels of the prediction factors of the patient to be prognosticated are each similar to the expression level of the good prognosis group or the expression level of the poor prognosis group;
selecting poor prognosis determining factors, which are genes indicating a poor prognosis, from the prediction factors of the patient to be prognosticated and extracting, from the poor prognosis determining factors, poor prognosis determining factors in which increase and decrease trends of expression levels coincide with increase and decrease trends of expression levels supposed when abnormal phenomena related to predetermined diseases occur; and
outputting, when the prognosis of the patient to be prognosticated is predicted to be poor in the determining step, the poor prognosis determining factors extracted for the respective abnormal phenomena.
